(19) United States
(12) Patent Application Publication
(10) Pub. No.: US 2026/0225513 A1
(43) Pub. Date: Aug. 6, 2026

(54) A System And Method For Handling Construction Material

(71) Applicant: Cairns Complete Plaster Services Pty Ltd, East Trinity (AU)

(72) Inventors: Bradley Richard Morgan, East Trinity (AU); Kevin John Ganly, East Trinity (AU)

(21) Appl. No.: 19/155,431

(22) PCT Filed: Feb. 22, 2024
(86) PCT No.: PCT/AU2024/050136

§ 371 Date: Aug. 11, 2025

(30) Foreign Application Priority Data
Feb. 23, 2023 (AU) 2023900467

(51) Int. Cl. B60P 1/64; B60P 1/22; B60P 1/43

(52) U.S. Cl. CPC B60P 1/6454; B60P 1/22; B60P 1/43

(57) ABSTRACT

A system is provided for unloading sheets of material from a tilt tray of a tilt truck. A trolley is loadable onto the tilt tray. The trolley has a support surface onto which the sheets of material can be supported. The support surface has a plurality of rollers over which the sheets of material can roll. The trolley has at least first wheels and second wheels arranged along an elongate axis. In use, the trolley is configured to be movable relative to the tilt truck so that when the tilt tray is tilted the trolley can be lowered until at least the second wheels roll off the second end of the tilt tray and contact the ground. The first wheels can remain on the tilt tray. The sheets of material can roll over the plurality of rollers, off the trolley, and at least partially onto the ground. The trolley can then be raised until at least the first wheels roll back onto the tilt tray, leaving only the sheets of material on the ground.

This application claims priority from AU2023900467 entitled A system and method for handling construction material filed on 23 Feb. 2023 the contents of which are hereby incorporated by reference in their entirety.

### TECHNICAL FIELD

The present invention relates to a system and method for handling construction material such as gypsum board sometimes referred to as drywall or plasterboard, and associated materials.

### BACKGROUND

The Gypsum Board Manufacturers of Australasia (GBMA) have issued Safe Site Guidelines. In those Guidelines, it is made clear that the wall and ceiling industries are concerned about the safe on-site delivery and storage of plasterboard.

As stated in those Guidelines “Experience has shown that improperly handled and stored plasterboard can represent a safety risk . . . Every site principal, builder and plastering contractor has a duty of care to ensure the provision of a safe workplace. The failure to provide such a safe workplace is an offence which could attract severe penalties. Implementing the work practices in the guide can assist you to demonstrate that you have exercised proper ‘duty of care’.”

Each sheet of plasterboard can weigh between 20 and 50 kg depending on its size. A standard sizing is 6000×1250×10 mm which weighs about 47.79 kg. Due to the weight, load restrictions apply to the number of plasterboard sheets that can be stacked horizontally. The size of the load is dependent upon the type of floor material. On concrete floors, 30 sheets maximum (approx. 300 mm) is permitted with no other material stacked within 1 metre of the plasterboard stack on concrete floors.

As expected, due to the weight of plasterboard, the delivery and unloading of multiple layers of plasterboard from trucks is not straightforward. The delivery of plasterboard is usually from a flatbed truck. A crane can be used to unload the plasterboard from the back of the flatbed truck, but this has the disadvantage that delivery into e.g. a carport or other undercover space is difficult due to the 0roof. In order to get plasterboard sheets into a carport or similar, manual handling is required where 1 (or preferably 2) persons move each sheet from the flatbed truck, or from the location of delivery by the crane, to the desired undercover location.

Accordingly, there exists a need for an improved system and method for delivering plasterboard that overcomes at least some of the problems of the prior art, or which at least provides a useful alternative.

### SUMMARY OF INVENTION

In a first aspect there is provided a system for unloading sheets of material from a tilt tray of a tilt truck, the tilt tray having a first end and a second end along a tilt tray elongate axis that is tiltable with respect to the truck, the system comprising,
a trolley loadable onto the tilt tray, the trolley having a support surface onto which the sheets of material can be supported, the support surface having a plurality of rollers over which the sheets of material can roll, the trolley further having a trolley elongate axis with a barrier at a loading/unloading end;
the trolley having at least first wheels and second wheels along the trolley elongate axis and associated with the support surface;
the trolley configured to be movable relative to the tilt truck optionally by means of a winch;
wherein, when the tilt tray is tilted:
lowering the trolley optionally using the winch until at least the second wheels roll off the second end of the tilt tray and contact the ground for rolling along the ground;
allowing the first wheels to remain on the tilt tray;
removing the barrier at the loading/loading end of the trolley thereby allowing the sheets of material to roll over the plurality of rollers, off the trolley, and at least partially onto the ground,
raising the trolley optionally using the winch until at least the first wheels roll back onto the tilt tray, leaving only the sheets of material on the ground.

A tilt tray truck has a tilt tray (or “tray”) that can be tilted at an angle such that the rear edge touches (or at least gets very near to) the ground. The tray can be tilted by hydraulics or other automation. The tilt tray facilitates the loading and or unloading of heavy equipment onto or off the bed of the truck without the use of any type of crane or boom. The present invention allows for the delivery of plasterboard from a tilt tray on a truck. The tilt tray has a first end located near the cab of the truck. The tilt tray has a second end remote from the first end which is the end where items can be loaded or unloaded onto the tilt tray on the truck. The tilt tray is typically the length of the truck and is usually longer than the width.

Accordingly, the tilt tray can be said to have an elongate axis for reference purposes. The tilt tray (along its elongate axis) is tiltable with respect to the truck. The amount of tilt permitted will be limited by the machinery used for the lifting and lowering. The user will understand how the tray can be tilted using the onboard controls.

A tilt tray typically has a winch located at the first end of the tilt tray which can assist in the loading of material by pulling it up onto the tray. The winch can be secured to the load and then a force can be applied to pull the load onto the truck. The winch can also help to control the slide of the loaded material off the tilted tray under forces of gravity. A problem with sheet of material, such as plasterboard, as a load is that, with multiple sheets in a stack, it is difficult for the winch to control all of them when gravity takes over. If the sheets start to slide off the tilt tray under gravity, they are unlikely to slide in a stack and instead the surfaces of the plasterboard sheets will slide over one another. The result would be a pile of sheets fallen off the tilt tray that require manual lifting to reorganise and restack.

The present inventors have modified the tilt tray to make it suitable for handling sheets of material such as plasterboard. This modification includes a tray, dolly, deck or trolley which allows for the handling of the sheet of material in a stack by supporting the stack from underneath. Whilst a trolley loaded onto the tilt tray is ideal, it is derisible not to leave the trolley on site with the sheets of material. Leaving the trolley on site means that the user has to remember where they left each trolley and return to collect it. Furthermore, multiple trolleys would be required while one was in use under a stack of delivered material. Instead, the trolley is reusable. It is used to deliver the sheets of material and then reloaded onto the truck for the next delivery. The trolley is configured to allow for the delivery of the sheets of material, and then the trolley is loaded back onto the tilt tray truck for further use. Only the sheets of material are left behind after delivery.

The trolley can be reloaded back onto the truck by winching it out from under the sheets of material that are partially on the ground. Optionally, the sheets of material could be jacked up once on the ground and the trolley removed out from under them. However, it has been found that the trolley can be removed by sliding it out from under the sheets which are partially on the ground.

The sheets of material are described herein as plasterboard, although it should be understood that the present invention can be used for any sheets of material.

Furthermore, the present invention can also be used for items other than sheets such as one or more of packages, boxes, blocks, wooden struts, frames, etc. The system of the invention lends itself in particular to elongate items which are difficult to handle but are readily delivered by the present process.

The trolley has a support surface onto which the sheets of material can be supported. The surface can be a continuous enclosed piece. The surface can have openings to minimise the amount of material used over the surface area. The surface be formed by a frame. The frame can be any size that is large enough to provide support to the sheets of material. The frame can be at least about 1.5 or 2 m in width. The frame can be at least about 5, 5.5 or 6 m in length (the dimensions can vary). In one or all embodiments, to withstand the applied load, the frame is a welded steel frame. The welded steel frame can be about 150, 200 or 250 mm thick. The frame can comprise cross bracing using, for example, parallel flange channels, and gussets. Any surface onto which the load can be supported is within spirit and scope.

The trolley naturally has an elongate axis that is in use substantially aligned with the elongate axis of the tilt tray. The trolley can have a first end near to the cab of the truck when loaded on the tilt tray. The trolley can have a second end remote from the first end. The second end can be referred to as a loading/unloading end because this is the end from which the material is loaded and unloaded.

There can be a barrier at the loading unloading end. The barrier can be moved from an open to a closed position. The barrier can be opened when the material is loaded or unloaded. The barrier can be closed when the material is being transported or during the unloading process when it is desirable that the material does not move. As the material falls under forces of gravity, the barrier prevents the material from moving off the trolley. As such, the barrier must be robust and not movable under the weight of the material. As the tray is being tilted forces will be applied onto the face of the barrier. When the trolley is in the desired position for unloading, the barrier can be opened (or removed). The movement of the barrier can be manual or automatic. The barrier can be lowered to provide an extension of the trolley. The sheets of material can slide over the lowered barrier. The barrier wall can be a fold down ramp.

In use, in addition to the barrier wall, the load is secured by straps. The straps tie down the load that is mounted on rollers. In one or all embodiments, the rollers can be locked during transport to reduce unwanted movement. As an alternative to locking, the rollers could be motorised, which would allow them to be non-moving during transport, but moving when desired to shift the load. In a further embodiment, there could be securing rams, air jacks, or airbag supports positioned on the trolley and below the load to push a channel (jacking beam) upwards so the weight of sheets is off the rollers while travelling. In use, any suitable beam, framing element or packer may be used to reduce unwanted movement of the load relative to the trolley during transport.

The trolley may be provided with connection points to assist in securing the load to the trolley and/or the trolley to the trailer.

The support surface has a plurality of rollers over which the sheets of material can roll. The rollers can be spaced along the elongate axis. The spacing can be at least about 500, 600, 700 or 800 mm. Preferably, the spacing between the rollers is a relatively small increment of the length of the material being delivered. The rollers can extend along the entire length of the support surface. Each roller can extend along the entire width of the support surface. However, rollers with a shorter longitudinal axis may roll more freely. Accordingly, in one or all embodiments there are a plurality of short rollers along the width of the support surface. There can be two rollers arranged along the width of the support surface. Each roller can comprise a tube or rod rotatable about a spindle. Each spindle can be located into a mount. In an alternative embodiment, each roller is a wheel mounted along a spindle. There can be multiple wheels spaced from one another to allow for rolling along the width of the support surface. The rollers can be the same along the support surface or they can differ over the support surface.

The rollers could be motorised to assist in controlling the loading and unloading of the load off the trolley. In use, motorised rollers may be used instead of, or in addition, to using the winch to deliver the load off of the trolley. This arrangement can be an advantage because it reduces (or eliminates) the need to transfer the winch from the trolley to the load and may provide additional control when using the winch to lower (or draw up) heavy or fragile loads from the trolley.

One or more of the rollers may be motorised. In embodiments, at least the back roller may be motorised. The motorised rollers may be controlled by an operator wirelessly by remote control, or by wired control.

The rollers can be provided with a gripping surface for better traction and to help absorb shock when conveying the load. The gripping surface may be provided for example by a coating adhered to the roller or a traction layer wrapped around the roller surface. The traction layer may be removably adhered to the roller surface or may comprise a roller cover configured to be in frictional engagement with the roller surface. The traction layer may be fabricated from an elastomeric material, such as a natural rubber, silicone, polypropylene, polyethylene, or the like. In embodiments, the rollers may be provided with a rubber cover.

In embodiments in which there is a trolley, the trolley can have a plurality of wheels arranged on its underside. The wheels can be mounted in any way that allow then to contact the ground. The wheels can be mounted to the underside of the trolley. Alternatively, in one or all embodiments, the wheels are suspended by arm bars which extend outwardly from the upper surface of the frame of the trolley. The part of the wheels which touch the ground is still on the underside of the trolley but the body of the wheel is alongside the frame. This arrangement can be an advantage because it is desirable that the trolley has as low a profile as possible. If the trolley is too high off the ground, it can be difficult for the sheets of material to slide off onto the ground. Furthermore, the height of the stack of the sheet of material needs to be lower once loaded onto the truck so that the sheets do not get higher than the top of the cab of the truck.

While wheels are described any roller or means of rolling can be used. Furthermore, while pairs of wheels are described, it should be understood that there could be more than two wheels along an axle. There can be at least two wheels but there could be more than two. In one or all embodiments, trolley wheels are used that can each withstand a load of about 2, 2.5 or 3 tonnes. The wheels can be at least about 150, 200 or 250 mm in diameter. When associated with the frame, preferably the width of the wheel plus frame does not exceed 250, 300 or 350 mm.

There can be a first pair of wheels. The first pair of wheels are located at the first end of the tilt tray when the trolley is mounted thereon. The first pair of wheels stay on the tilt tray of the truck during transport and delivery. The first pair of wheels provide a pivot point around which the trolley pivot when the trolley slides off the tilt tray. There can be a mechanism for preventing the first pair of wheels from leaving the tilt tray of the truck. In one or all embodiments as described, the first pair of wheels can be replaced by a permanent pivot point on the truck where the trolley becomes a second tilt tray.

There can be a second pair of wheels. When the trolley is loaded onto the tilt tray, the second pair of wheels will be located at the second end of the tilt tray. The second pair of wheels can be located at the loading/unloading end of the trolley. Thus, the second pair of wheels is spaced from the first pair of wheels. In one or all embodiments in which the frame is about 5.5 m in length, the first pair of wheels can be spaced by at about 5.5 m from the second pair of wheels. The second pair of wheels can be located just inward of the loading/unloading end of the trolley. The second pair of wheels can include a brake to stop the wheels rolling once they hit the ground. The brake can be any means for stopping the wheel from rolling.

The wheels may be fixed or may be configured to swivel relative to the elongate axis of the trolley. In embodiments, the second pair of wheels may be configured to swivel. The wheels may be lockable so as to prevent the wheels from swivelling during movement of the trolley.

It has been found that by having additional wheels such as an intermediate pair of wheels, located between the first pair of wheels and the second pair of wheels along the trolley elongate axis there are advantages. An advantage can be additional cantilevering of the back of the trolley the incline of the ground is steep during delivery. In one or all embodiments, the intermediate wheels are located about one third of the distance from the first wheels (with two thirds of the distance being to the second wheels). In one or all embodiments in which the wheels are spaced about 5.5 m from one another, the intermediate wheels are located at about 3.68 m from the first wheels.

The sheets of plasterboard can be loaded onto the trolley. The trolley can then be mounted onto the tilt tray using the winch. The sheets of plasterboard can then be taken to the location at which they will be delivered.

In order to deliver the sheets of material, the truck is reversed to the required location. The location can be a carport. The tilt tray can be tilted using the onboard hydraulics. The trolley will not yet move because it is held by the winch. The trolley can be lowered by the winch as the tray is tilted or once the tray has reached the final tilt. The trolley is lowered until at least the second pair of wheels roll off the second end of the tilt tray and contact the ground. The second wheels are allowed to roll along the ground to extend the trolley out from the truck. The first wheels remain on the tilt tray of the truck. The trolley is locked into position by locking the wheels and or by using an arrangement of chains that ensure the trolley will not move once the winch is disconnected from the trolley. The winch can be disconnected from the trolley and transferred to the sheets of material. The sheets of material can comprise a sling around then to which the winch can be connected. The barrier ramp is opened (lowered). The sheets can be lowered by the winch and roll down the rollers until they contact the ground. Alternatively, or in addition, motorised rollers could be used in place of the winch. The sheets of material will slide off the trolley onto the ground. Some of the load will be on the ground, while some of the load will remain on the support surface. At least about 10, 15 or 20 % of the load can extend off the trolley and contact the ground. The winch can be used to draw up the trolley leaving the sheets behind on the ground. If necessary the truck can move forward to further release the sheets from the trolley.

Initially, the present inventors considered adding rollers directly to the surface of the tilt tray (without a trolley) in an attempt to get the sheets of material to slide as one stack. However, it was discovered that for safety, a trolley is required that moves separately to the tilt tray. The trolley allows for more control over the delivery of the sheets by decreasing the tilt of the stack of sheets prior to delivery while the edges of the sheets are closer to the ground. The trolley is essentially a telescopic extension of the tilt tray. Thus, the invention could be recast wherein the trolley is defined as a second tilt tray which moves telescopically with respect to the first tilt tray. This arrangement would take all the advantages of the invention and thus can be defined as follows:

Thus in a second aspect there is provided a system for unloading sheets of material from a tilt tray of a tilt truck, the tilt tray comprising:
a first tilt tray having a first end and a second end; and
a second tilt tray mounted on top of the first tilt tray and telescopically associated with the first tilt tray, the second tilt tray having:
   a support surface onto which the sheets of material can be supported, the support surface having a plurality of rollers over which the sheets of material can roll;
   a sliding end and a loading/unloading end;
   a barrier at the loading/unloading end;
   arranged on its underside, at least a second pair of wheels at the loading/unloading end;
wherein, when the tilt tray is tilted
the second tilt tray is lowered by sliding over the first tilt tray, but remaining connected thereto at the sliding end thereof, the second tilt tray sliding until at least the second pair of wheels roll off the second end of the first tilt tray and contact the ground for rolling along the ground;
the barrier at the loading/loading end of the second tilt tray can be removed to allow the sheets of material to roll over the plurality of rollers, off the second tilt tray, and at least partially onto the ground;
the second tilt tray is raised back by sliding back over the first tilt tray, until the second pair of wheels roll back onto the first tilt tray, leaving only the sheets of material on the ground.

In this embodiment, fewer wheels are required because the association between the first tilt tray and the second tilt tray differs to when a trolley is involved. Whilst this embodiment would work in a similar way to the embodiment in which a trolley is involved, it has the drawback that the trolley is not removable from the tilt truck. This means that the sheets of material have to be loaded directly onto the tilt truck, rather than being loaded onto a trolley which can be moved to the tilt truck. The invention herein is described in terms of having a trolley since this is a preferred embodiment. However, it should be understood that the trolley wording could be replaced with “second tilt tray” unless the context makes clear otherwise.

In another aspect there is provided a system for unloading sheets of material from a tilt tray of a tilt truck, the tilt tray having a first end and a second end along a tilt tray elongate axis that is tiltable with respect to the truck, the system comprising,
a trolley loadable onto the tilt tray, the trolley having a support surface onto which the sheets of material can be supported, the support surface having a loading surface onto which the sheets of material can be placed, the trolley further having a trolley elongate axis with a barrier at a loading/unloading end;
the trolley having at least first wheels and second wheels along the trolley elongate axis and associated with the support surface;
the trolley configured to be movable relative to the tilt truck optionally by means of a winch;
wherein, when the tilt tray is tilted:
lowering the trolley optionally using the winch until the first wheels and second wheels roll off the second end of the tilt tray and contact the ground for rolling along the ground;
leaving the trolley with the sheets of materials in location.

In this embodiment, since the sheets of material will not be slidingly removed from the trolley support surface, the trolley does not need to comprise surface rollers. Alternatively, if there are surface rollers, these are locked so that the sheets of material cannot roll off the trolley. The trolley can be left in its unloaded location and the sheets of material can be used as desired. Optionally, the trolley can be collected once at least some of the sheets of material have been used.

### BRIEF DESCRIPTION OF THE FIGURES

Embodiments of the invention will now be described with reference to the accompanying drawings which are not drawn to scale and which are exemplary only and in which:

FIG. 1 is a perspective view of a trolley loaded onto to a tilt tray of a truck.

FIG. 2 is a close up view of intermediate and rear wheels (second wheels) of the trolley of FIG. 1.

FIG. 3 is a close up view of front wheels (first wheels) of the trolley of FIG. 1.

FIG. 4 shows the barrier wall at the end of the trolley of FIG. 1.

FIG. 5 is a close up of the rollers joined to the frame of the trolley of FIG. 1.

FIG. 6A to D is a schematic of the delivery process using the trolley according to an embodiment of the invention.

FIG. 7 is an embodiment in which the ground for delivery is inclined.

FIG. 8A to C is a schematic of a delivery process according to another embodiment of the invention.

### DETAILED DESCRIPTION OF EMBODIMENTS OF THE INVENTION

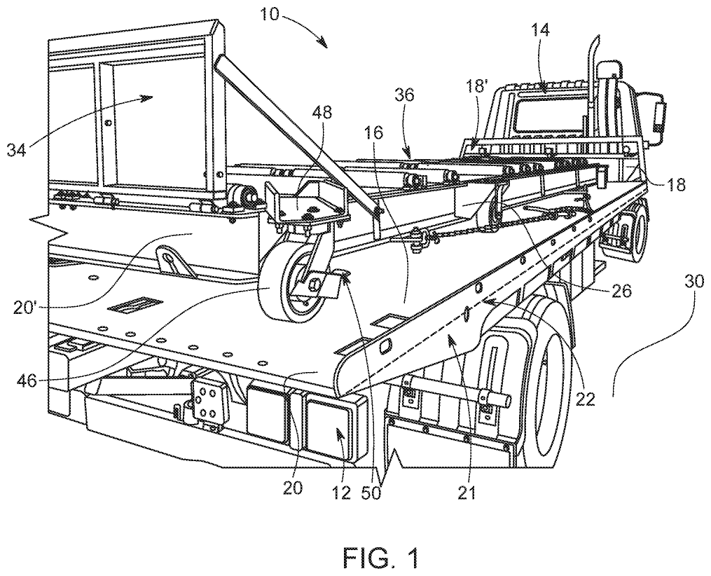

A tilt tray truck 10 has a tilt tray 16 (or “tray”) that can be tilted at an angle such that the rear edge touches (or at least gets very near to) the ground. In FIG. 1, the tilt tray 16 of the truck 10 is shown in the horizontal position loaded onto the truck.

The tilt tray 16 has a first end 18 located near the cab 14 of the truck 10. The tilt tray 16 has a second end 20 remote from the first end 18 which is the end where items can be loaded or unloaded onto the tilt tray 16 on the truck 10. The tilt tray 16 can have railings or barriers 21 along its side edges to prevent or reduce a likelihood that items will fall off during transport. The tilt tray 16, as shown, is typically the length of the truck 10. As is common with trucks, the length is usually longer than a width. Accordingly, the tilt tray 16 can be said to have an elongate axis 22 for reference purposes. In FIG. 1, the elongate axis is shown as a dotted line 22. The tilt tray 16 (along its elongate axis 22) is tiltable with respect to the truck 10. The amount of tilt permitted will be limited by the machinery used for the lifting and lowering. The user will understand how the tray 16 can be tilted using the onboard controls (not shown).

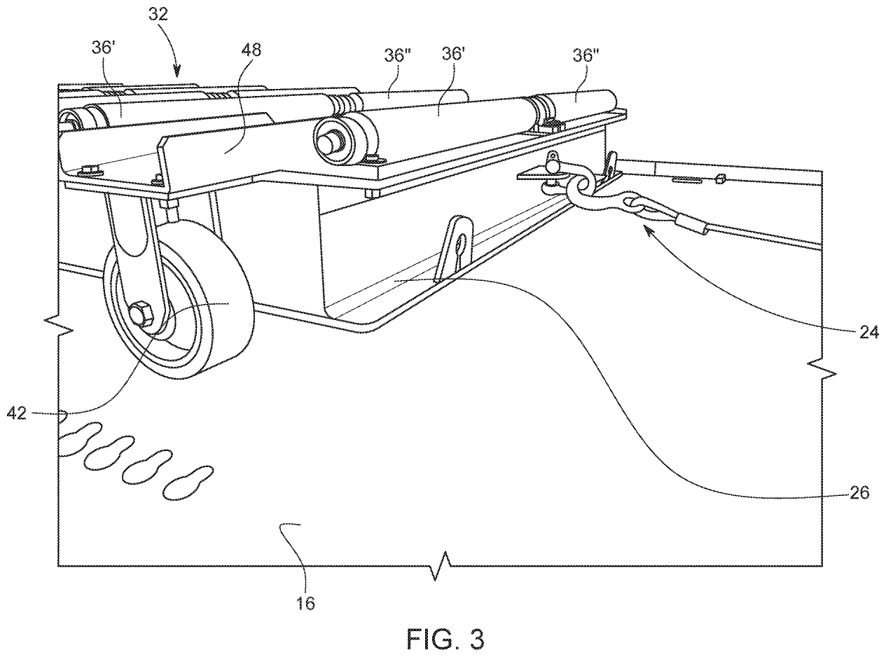

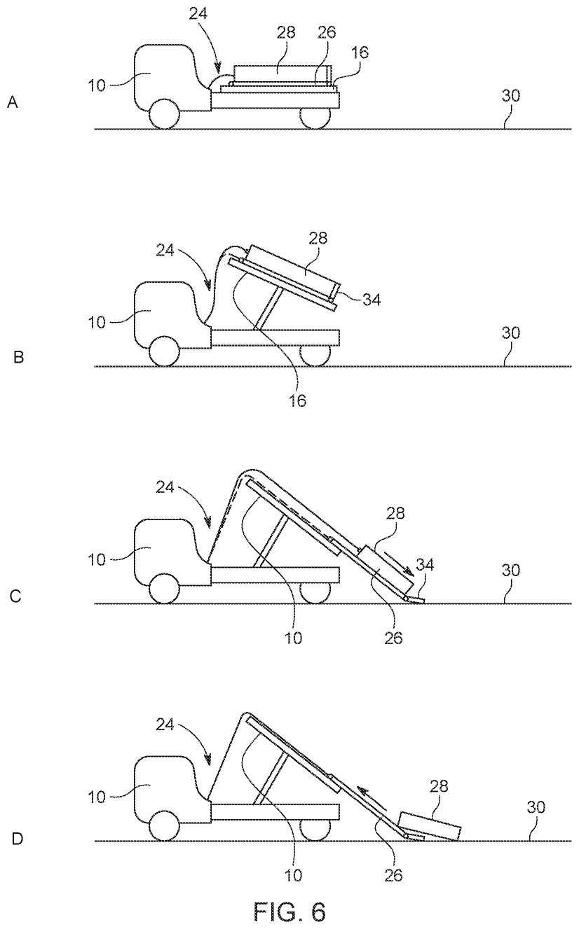

A tilt tray 16 typically has a winch 24 located at or towards the first end 18 of the tilt tray 16 which can assist in the loading of material by pulling it up onto the tray 16. The winch 24 can be secured to the load 28 or the trolley 26 as shown in FIG. 3 and FIG. 6. A force can be applied by the winch 24 to pull the load 28 onto the truck 10. The winch 24 can also help to secure load 28 during transport and or to control the slide of the loaded material 28 off the tilted tray 16 under forces of gravity when the tray 16 is tilted. The winch 24 can be used to lower the loaded material 28 off the tilt tray 16 in a controlled way.

The tray 16 of the truck 10 comprise a tray, dolly, deck or trolley 26 which allows for the handling of a load, such as sheets of material in a stack 28, by supporting the stack from underneath. The trolley is configured to allow for the delivery of the sheets of material, and then the trolley is loaded back onto the tilt tray truck for further use. Only the sheets of material are left behind after delivery.

The trolley 26 can be reloaded back onto the truck 10 by winching it out from under the sheets of material 28 that are partially on the ground 30 (see FIG. 6).

In the Figures, the load 28 is just shown as a box for illustration purposes. It should be understood that the load 28 can be sheets of material, items for delivery, anything that required delivery.

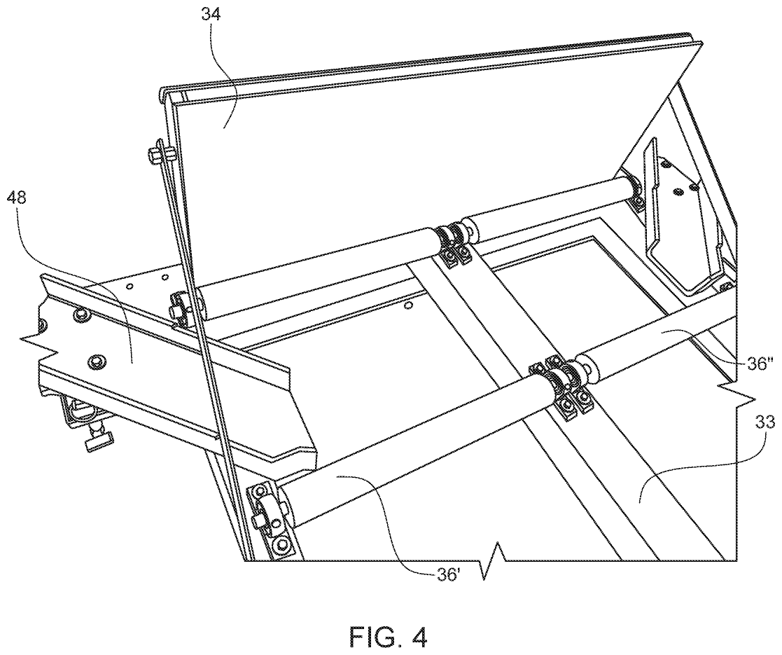

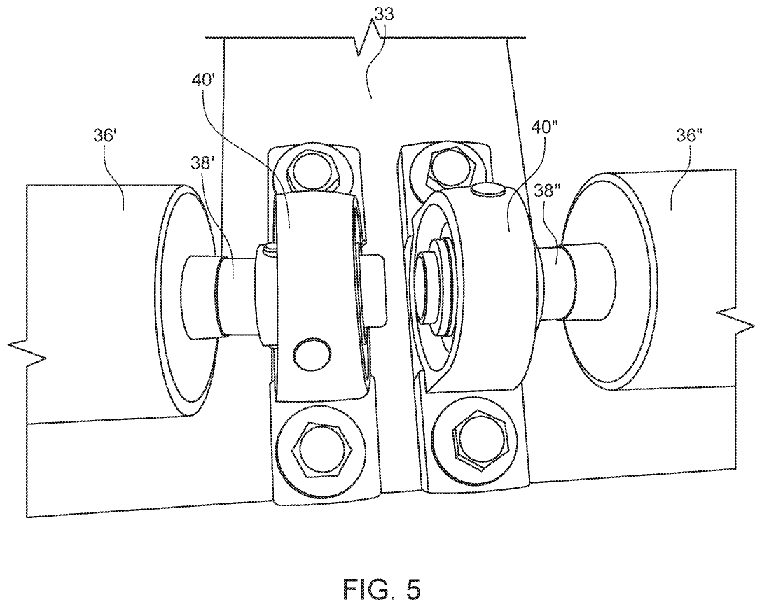

The trolley 26 has a support surface 32 onto which the sheets of material 28 can be supported. The surface 32 is shown in FIGS. 1 to 5 as a steel frame 33. The frame is about 1.5 m in width. The frame is about can be at least about 4.5 m in length (the dimensions can vary). The welded steel frame can be about 200 mm thick when made by steel beams.

The trolley 26 naturally has an elongate axis 22′ that is in use substantially aligned with the elongate axis 22 of the tilt tray 16 (see FIG. 1). The trolley 26 can have a first end 18′ near to the cab 14 of the truck 10 when loaded on the tilt tray 16. The trolley 26 can have a second end 20′ remote from the first end 18′. The second end 20′ can be referred to as a loading/unloading end because this is the end from which the material 28 is loaded and unloaded.

There can be a barrier 34 at the loading unloading end 20′. The barrier 34 can be moved from an open (FIGS. 6C and 6D) to a closed position (e.g. FIGS. 1, 2, 4 and 6A and 6B). The barrier 34 can be opened when the material 28 is loaded or unloaded. The barrier 38 can be closed when the material is being transported (FIG. 6A) or during the unloading process when it is desirable that the material does not move (FIG. 6B). As the material 28 falls under forces of gravity, the barrier 34 prevents the material 28 from moving off the trolley 34. As such, the barrier must be robust and not movable under the weight of the material. The barrier 34 can be lowered (FIG. 6C) to provide an extension of the trolley 26. The sheets of material 28 can slide over the lowered barrier 34. The barrier wall can be a fold down ramp 34.

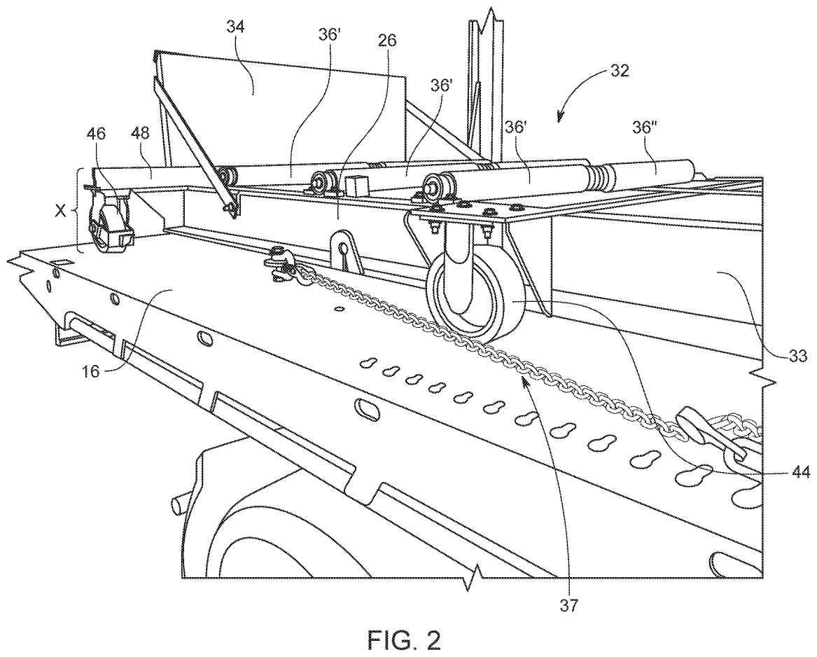

In use, in addition to the barrier wall 34, the load can be secured by securing straps which can be anything from webbing to chains 37. FIG. 2 shows the chains 37 for securing the trolley 26 secured to a connection point located on the trolley. It should be understood there would be other strapping to hold the load onto the trolley 26. The straps can secure the trolley and tie down the load 28 that is mounted on rollers 36. In one or all embodiments, the rollers 36 can be locked during transport to reduce unwanted movement.

The support surface 32 has a plurality of rollers 36 over which the sheets of material 28 can roll. The rollers 36 can be spaced along the elongate axis of the trolley 26. The rollers 36 are shown extending along the entire length of the support surface 32. Each roller 36 is shown in two roller parts 36′ and 36″. Each roller 36 can comprise a tube or rod rotatable about a spindle 38. Each spindle 38 can be located into a mount 40.

The rollers 36 can be provided with a gripping surface, such as an elastomeric material, for example a rubber material, for frictionally engaging the load 28 for better traction and shock absorption.

The rollers 36 can be motorised to provide additional control when loading or unloading the load 28 from the trolley 26. The back rollers, that is the rollers distal the cab of the vehicle may be motorised to provide additional control during loading and unloading of the load 28 from the trailer.

The trolley 26 can have a plurality of wheels 42, 44, 46 arranged on its underside. The wheels 42, 44, 46 can be mounted in any way that allow then to contact the ground 30. The wheels 42, 44, 46 can be mounted to the underside of the trolley 26. Alternatively, In one or all embodiments as shown in FIGS. 1, 2 and 3, the wheels 42, 44, 46 are suspended by arm bars 48 which extend outwardly from the upper surface of the frame 33 of the trolley 26. The plurality of wheels may be configured to swivel or may be fixed. In one or all embodiments as shown in FIGS. 1 and 2, the wheels 46 are configured to swivel relative to the elongate axis of the trolley 26 while wheels 44 are fixed and are unable to swivel. Wheels 46 are lockable.

While wheels 42, 44, 46 are described any roller or means of rolling can be used. Furthermore, while pairs of wheels are sometimes described, it should be understood that there could be more than two wheels along an axle. There can be at least two wheels but there could be more than two. The wheels 42, 44, 46 can be about 200 mm in diameter. When associated with the frame 33, preferably the width of the wheel 42, 44, 46 plus frame does not exceed 300 mm (marked as X on FIG. 2).

There can be a first pair of wheels 42. The first wheels 42 are located at the first end 18 of the tilt tray 16 when the trolley 26 is mounted thereon (see FIGS. 1 and 3). The first pair of wheels 42 stay on the tilt tray of the truck during transport and delivery (refer FIG. 6). The first pair of wheels 42 provide a pivot point around which the trolley pivot (FIG. 6C) when the trolley 26 slides off the tilt tray 16. There can be a mechanism for preventing the first pair of wheels 42 from leaving the tilt tray 16 of the truck 10. In one or all embodiments as described, the first pair of wheels 42 can be replaced by a permanent pivot point on the truck where the trolley becomes a second tilt tray 26.

There can be a second pair of wheels 46. When the trolley 26 is loaded onto the tilt tray 16, the second pair of wheels 46 will be located at the second end 20 of the tilt tray 16. The second wheels 46 can be located at the loading/unloading end of the trolley 16. Thus, the second wheels 46 are spaced from the first pair of wheels 42. The second wheels 46 can include a brake 50 to stop the wheels rolling once they hit the ground 30. The brake 50 can be a friction brake 50.

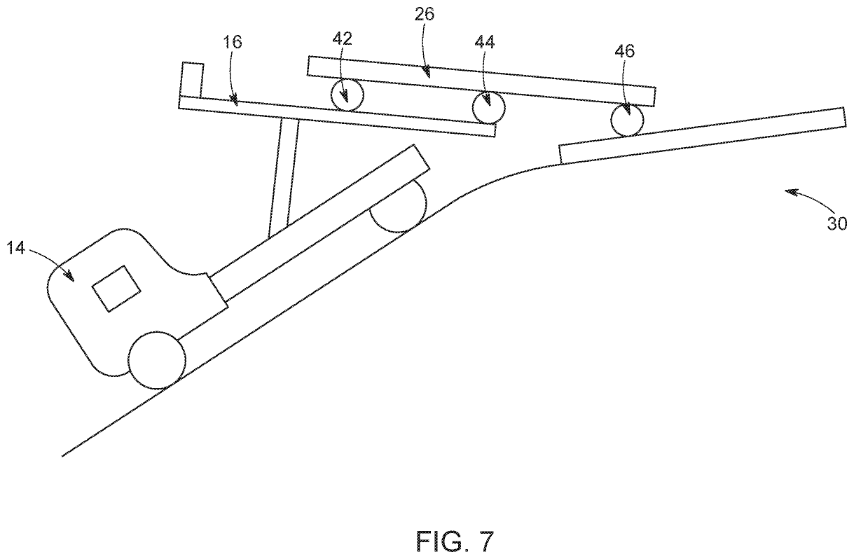

It has been found that by having additional wheels such as an intermediate pair of wheels 44, located between the first pair of wheels 42 and the second pair of wheels 46 along the trolley 16 elongate axis there are advantages. An advantage can be additional cantilevering of the back of the trolley 16 when the incline of the ground 30 is steep during delivery (FIG. 7).

The sheets of plasterboard 28 or other material can be loaded onto the trolley 26. When sheets are loaded at the warehouse the trolley 26 can be on the tilt tray 16 and a forklift with spreader bars can be used to load the sheets 28. Spreader bar widths differ between manufacturers. In the present embodiment, the frame 33 has rollers 36 spaced on the trolley 26 to accommodate the spreader bars of the forklift. The load e.g. sheets of plasterboard 28 can then be taken to the location at which they will be delivered.

In order to deliver the sheets of material 28, the truck 10 is reversed to the required location. The location can be a carport. The concrete slab 30 of a carport is shown in FIG. 7. The tilt tray 16 can be tilted as shown in FIG. 6B using the onboard hydraulics. A schematic of a hydraulic arm under the tilt tray 16 is shown in FIG. 6, but the mechanism can be any known in the art. The trolley 26 will not yet move because it is held by the winch 24. In FIG. 6B the winch is shown attachable to either or both the trolley 26 and or load 28. In FIG. 6C the winch is shown attachable to either or both the trolley 26 and or load 28. The trolley 26 is lowered until at least the second wheels 46 roll off the second end 20 of the tilt tray 16 and contact the ground 30 (FIG. 6C). The second wheels 46 are allowed to roll along the ground to extend the trolley out from the truck (FIG. 6C). The first wheels 42 remain on the tilt tray 16 of the truck 10. The trolley 26 is locked into position by locking the wheels 46 and or by using an arrangement of chains 37 that ensure the trolley 26 will not move once the winch 24 is disconnected from the trolley 26. The winch 24 is disconnected from the trolley 26 and transferred to the sheets of material 28. The sheets of material can comprise a sling around then to which the winch 24 can be connected. The barrier ramp 34 is opened (lowered). The sheets are lowered by the winch 24 and roll down the rollers 36 until they contact the ground 30 (FIG. 6C). The sheets of material will slide off the trolley 26 onto the ground 30. Some of the load 28 will be on the ground 30, while some of the load 28 will remain on the support surface 32. The winch 24 can be used to draw up the trolley 26 in the direction of the arrow in FIG. 6D leaving the sheets 28 behind on the ground 30.

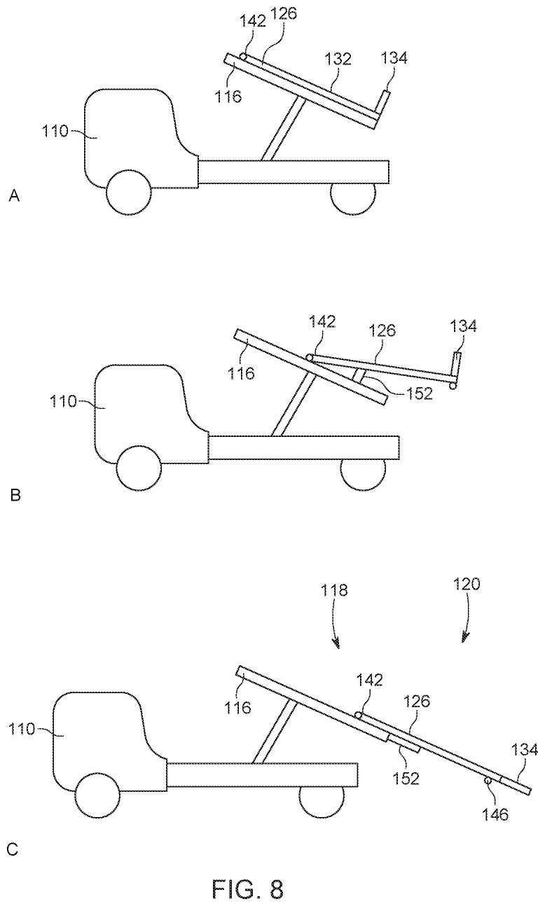

In one or all embodiments as shown in FIG. 8 there is a truck 110 with a first tilt tray 116 and a second tilt tray 126 mounted on top of the first tilt tray 116 and telescopically associated with the first tilt tray 116. The second tilt tray can slide along rails in the first tilt tray along pivot point 142. The second tilt tray 126 has a support surface 132 onto which the sheets of material (not shown) can be supported. The support surface 132 can have a plurality of rollers. The second tilt tray can have a sliding end 118 and a loading/unloading end 120. A barrier 134 can be located at the loading/unloading end 120. Wheels 146 could be located at the loading/unloading end 120. When the tilt tray is tilted as shown in FIG. 8, the second tilt tray 126 can be lowered by telescopically sliding over the first tilt tray 116. A second hydraulic arm 152 can be associated with the second tilt tray for control. The second tilt tray 126 can slide until at least the second wheels 146 roll off the second end 120 of the first tilt tray 116 and contact the ground 130 for rolling along the ground. The barrier 134 at the loading/loading end 120 of the second tilt tray 126 can be removed to allow the sheets of material to roll over the plurality of rollers, off the second tilt tray 126, and at least partially onto the ground 130. After delivery, the second tilt tray 126 can be raised back by telescopically sliding back over the first tilt tray 116, until the second wheels 146 roll back onto the first tilt tray 116, leaving only the sheets of material on the ground 130.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

1. A system for unloading sheets of material from a tilt tray of a tilt truck, the tilt tray having a first end and a second end along a tilt tray elongate axis that is tiltable with respect to the truck, the system comprising,
a trolley loadable onto the tilt tray, the trolley having a support surface onto which the sheets of material can be supported, the support surface having a plurality of rollers over which the sheets of material can roll, the trolley further having a trolley elongate axis with a barrier at a loading/unloading end;
the trolley having at least first wheels and second wheels arranged along the trolley elongate axis and associated with the support surface;
the trolley configured to be movable relative to the tilt truck; wherein, when the tilt tray is tilted:
lowering the trolley until at least the second wheels roll off the second end of the tilt tray and contact the ground for rolling along the ground;
allowing the first wheels to remain on the tilt tray;
removing the barrier at the loading/loading end of the trolley thereby allowing the sheets of material to roll over the plurality of rollers, off the trolley, and at least partially onto the ground,
raising the trolley until at least the first wheels roll back onto the tilt tray, leaving only the sheets of material on the ground.

2. The system of claim 1, wherein there is a pair of first wheels and a pair of second wheels and intermediate wheels located between the first wheels and the second wheels along the trolley elongate axis.

3. The system of claim 2, wherein the first wheels are located at a first end of the trolley and the second wheels are located at the loading/loading end of the trolley, and the intermediate wheels are located about one third of the distance along the elongate axis between the first wheels and the second wheels.

4. The system of claim 2, wherein the intermediate wheels roll off the second end of the tilt tray when the tray is tilted and the trolley is lowered; and wherein the intermediate wheels roll back onto the tilt tray during raising.

5. The system of claim 1, wherein the first wheels and the second wheels are mounted on arm bars in order to reduce the distance of the support surface of the trolley to the ground.

6. The system of claim 5, wherein a distance of the support surface to the ground does not exceed about 300 mm including the height of the wheels.

7. The system of claim 1, wherein the second wheels are lockable once on the required location on the ground.

8. The system of claim 1, wherein the trolley is raised and lowered using a winch associated with the truck.

9. The system of claim 1, wherein the barrier is a ramp hingedly connected to the trolley.

10. The system of claim 1, wherein the rollers are provided in two roller parts which together extend the width of the trolley.

11. The system of claim 1, wherein the rollers are lockable to prevent rotation until desired.

12. The system of claim 1, wherein at least some of the rollers are motorised to assist in the sheets of material rolling over the plurality of rollers.

13. The system of claim 1, wherein at least some of the rollers comprise a gripping surface.

14. The system of claim 1, wherein there is a mechanism to lift the weight of the plurality of sheets is off the rollers.

15. The system of claim 1, wherein the sheets of material are plasterboard.

16. (canceled)

17. A trolley configured to be loaded onto a tilt tray of a truck, the trolley for assisting in the unloading sheets of material from the tilt tray of the tilt truck, the tilt tray having a first end and a second end along a tilt tray elongate axis that is tiltable with respect to the truck, the trolley comprising,
a support surface onto which the sheets of material can be supported, the support surface having a plurality of rollers over which the sheets of material can roll,
the trolley further having a trolley elongate axis with a barrier at a loading/unloading end of the elongate axis;
the trolley having at least a first pair of wheels, a second pair of wheels and an intermediate pair of wheels, wherein the intermediate pair of wheels are located between the first pair of wheels and the second pair of wheels along the trolley elongate axis;
the trolley configured to be movable relative to the tilt truck, wherein, when the tilt tray is tilted for delivery of a load the trolley is configured to:
be lowerable along the tilted axis of the tilt tray until at least the second pair of wheels roll off the second end of the tilt tray and contact the ground for rolling along the ground;
have a first pair of wheels that remain on the tilt tray during delivery;
allow the barrier at the loading/loading end of the trolley to be removed thereby allowing the sheets of material to roll over the plurality of rollers, off the trolley, and at least partially onto the ground,
be raised until at least the first wheels roll back onto the tilt tray, leaving only the sheets of material on the ground.

18. A system for unloading sheets of material from a tilt tray of a tilt truck, the tilt tray comprising: a first tilt tray having a first end and a second end; and a second tilt tray mounted on top of the first tilt tray and telescopically associated with the first tilt tray, the second tilt tray having:
a support surface onto which the sheets of material can be supported, the support surface having a plurality of rollers over which the sheets of material can roll;
a sliding end and a loading/unloading end;
a barrier at the loading/unloading end;
arranged on its underside, at least a second pair of wheels at the loading/unloading end;
wherein, when the tilt tray is tilted,
the second tilt tray is lowered by telescopically sliding over the first tilt tray, but remaining connected thereto at the sliding end thereof, the second tilt tray sliding until at least the second pair of wheels roll off the second end of the first tilt tray and contact the ground for rolling along the ground;
the barrier at the loading/loading end of the second tilt tray can be removed to allow the sheets of material to roll over the plurality of rollers, off the second tilt tray, and at least partially onto the ground;
the second tilt tray is raised back by telescopically sliding back over the first tilt tray, until the second pair of wheels roll back onto the first tilt tray, leaving only the sheets of material on the ground.

19. (canceled)

20. The trolley of claim 17, wherein the sheets of material are plasterboard.

21. The system of claim 18, wherein the sheets of material are plasterboard.
